(19) United States
(12) Patent Application Publication
(10) Pub. No.: US 2012/0136595 A1
(43) Pub. Date: May 31, 2012

(54) BATTERY DIFFUSION VOLTAGE ESTIMATION

(75) Inventors: Xidong Tang, Royal Oak, MI (US); Jian Lin, Beverly Hills, MI (US); Benjamin Thorsen, Novi, MI (US); Brian J. Koch, Berkley, MI (US); Kurt M. Johnson, Brighton, MI (US)

(73) Assignee: GM GLOBAL TECHNOLOGY OPERATIONS LLC, Detroit, MI (US)

(21) Appl. No.: 13/229,931

(22) Filed: Sep. 12, 2011

Related U.S. Application Data
(60) Provisional application No. 61/417,639, filed on Nov. 29, 2010.

(51) Int. Cl. G06F 19/00

(52) U.S. Cl. 702/63

(57) ABSTRACT

A method includes estimating a first diffusion voltage value of a battery by selecting the first diffusion voltage value from a look-up table, estimating a second diffusion voltage value of the battery using an estimation procedure, selecting at least one of the estimated first and second diffusion voltage values, and determining an open circuit voltage of the battery based at least in part on the selected diffusion voltage value. The method may be implemented by a computing device in a vehicle.

### CROSS-REFERENCE TO RELATED APPLICATIONS

This application claims priority to and the benefit of U.S. Provisional Patent Application No. 61/417,639 filed on Nov. 29, 2010, which is hereby incorporated by reference in its entirety.

### TECHNICAL FIELD

The disclosure relates to a battery diffusion voltage estimation procedure.

### BACKGROUND

Some passenger and commercial vehicles use batteries to power electronic components. In hybrid vehicles, one or more batteries may be used to provide electrical energy to a motor that provides a torque that propels the vehicle. The operation of various control modules in the vehicle may depend upon the battery state of charge (e.g., the residual capacity of the battery relative to the reserve capacity). Further, a driver of the vehicle may wish to know how much longer the vehicle may be used before the battery must be recharged.

### SUMMARY

A method in accordance with the present invention includes estimating a first diffusion voltage value of a battery by selecting the first diffusion voltage value from a look-up table and estimating a second diffusion voltage value of the battery using an estimation procedure. The method further includes selecting at least one of the estimated first and second diffusion voltage values, and determining, via a computing device, an open circuit voltage of the battery based at least in part on the selected diffusion voltage value.

A vehicle in accordance with the present invention includes a battery, at least one sensor, and a computing device. The sensor is configured to measure at least one of a terminal voltage, a terminal current, and a temperature of the battery. The computing device is configured to estimate a first diffusion voltage value and a second diffusion voltage value of the battery. The computing device is configured to estimate the first diffusion voltage value from a look-up table and the second diffusion voltage value of the battery using an estimation procedure. The computing device is further configured to select at least one of the estimated first and second diffusion voltage values and determine an open circuit voltage of the battery based at least in part on the selected diffusion voltage value.

The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a vehicle having a computing device configured to determine a diffusion voltage value of a battery.

FIG. 2 illustrates a representative circuit of an example battery that may be used in the vehicle of FIG. 1 to estimate the diffusion voltage value using a look-up procedure.

FIG. 3 illustrates a representative circuit of an example battery that may be used in the vehicle of FIG. 1 to estimate the diffusion voltage value using an estimation procedure.

FIG. 4 illustrates an example flowchart of the look-up procedure that may be used by the computing device of FIG. 1 to determine an open circuit voltage of the battery.

FIG. 5 illustrates an example flowchart of the estimation procedure that may be used by the computing device of FIG. 1 to determine an open circuit voltage of the battery.

FIG. 6 illustrates an example flowchart of a process that may be used by the computing device of FIG. 1 to fuse the look-up procedure of FIG. 4 and the estimation procedure of FIG. 5.

### DETAILED DESCRIPTION

FIG. 1 illustrates a vehicle 100 having a computing device that is configured to determine an open circuit voltage of a battery in real time based on at least two estimated diffusion voltage values. One diffusion voltage value may be selected from a look-up table and the other may be estimated using an estimation procedure. The open circuit voltage determination may be based on one of the two estimated diffusion voltage values deemed more accurate or reliable than the other. The vehicle 100 may take many different forms and include multiple and/or alternate components and facilities. While an example vehicle 100 is shown in the Figures, the components illustrated in the Figures are not intended to be limiting. Indeed, additional or alternative components and/or implementations may be used.

As illustrated in FIG. 1, the vehicle 100 may include a battery 105, one or more sensors 110, a computing device 115, and a memory device 120. The vehicle 100 may be any passenger or commercial automobile such as a hybrid electric vehicle including a plug-in hybrid electric vehicle (PHEV) or an extended range electric vehicle (EREV), a gas-powered vehicle, a battery electric vehicle (BEV), or the like.

The battery 105 may include any device configured to store and provide electrical energy to one or more electronic components in the vehicle 100. For instance, the battery 105 may include one or more cells that convert stored chemical energy into electrical energy. The cells of the battery 105 may be charged by applying an electric current that reverses chemical reactions in the cells that would otherwise occur if the battery 105 were providing electrical energy. In one possible approach, the battery 105 may include a lithium-ion battery pack. Further, the battery 105 may include a plurality of terminals 125 to provide electrical energy to the electronic components in the vehicle 100. The battery 105 may have one or more parameter values that are associated with a state of charge of the battery 105.

The sensor 110 may include any device configured to measure a terminal voltage, a terminal current, or a temperature of the battery 105 and generate one or more signals representing those measured characteristics. While only one sensor 110 is illustrated, the vehicle 100 may include any number of sensors 110. For instance, one sensor may be used to measure the terminal voltage, another sensor may be used to measure the terminal current, and a different sensor may be used to measure the temperature.

To measure the terminal voltage, the sensor 110 may include a digital or analog voltmeter configured to measure a difference in electrical potential across the terminals 125 of the battery 105. Alternatively, the sensor 110 may be configured to estimate or derive the voltage across the terminals 125 based on factors such as the current output of the battery 105, the temperature of the battery 105, and the resistance of components within the battery 105. The voltmeter may be configured to generate and output a signal representative of the electrical potential across the terminals 125 (e.g., the terminal voltage). To measure the terminal current, the sensor 110 may include any device configured to measure electrical current (e.g., direct current) and generate a signal representative of the magnitude of the current measured. An accumulated charge may be derived from the measured terminal current. To measure the temperature of the battery 105, the sensor 110 may include any device configured to measure a quantity of heat at one or more locations of the battery 105, including the ambient air surrounding the battery 105, and generate one or more signals that represent the highest, lowest, average, and/or median temperature measured.

The computing device 115 may include any device or devices configured to determine an open circuit (e.g., no load) voltage of the battery 105 based upon one or more estimated values of a diffusion voltage. The open circuit voltage may be used in various calculations by the computing device 115 or other control modules (not shown) in the vehicle 100. For instance, the open circuit voltage may be used to calculate the state of charge, the state of health, the reserve capacity, etc. of the battery 105. Accordingly, the computing device 115 may be configured to generate a signal representing the open circuit voltage and may output that signal to other components, such as control modules, in the vehicle 100.

The computing device 115 may be configured to develop and/or access an expression that defines the voltage of the battery 105. An example expression for purposes of illustration may be as follows:

V(k)=θ₁V(k−1)+θ₂V(k−2)+θ₃I(k)+θ₄I(k−1)+θ₅I(k−2)+θ₆ (1)

where V is the terminal voltage, I is the terminal current, k represents the present time step, and θ₁, θ₂, θ₃, θ₄, θ₅, and θ₆ are model parameters that may be functions of one or more of temperature, the state of charge, and the state of health of the battery 105. Other parameter values, as discussed in greater detail below, may be further defined in expressions developed by or accessible to the computing device 115. The computing device 115 may be configured to estimate or derive one or more of the parameter values associated with the state of health of the battery 105, as well as determine the state of charge of the battery 105.

In one possible approach, the computing device 115 may be configured to determine a change in the open circuit voltage of the battery 105 over time and a change in the state of charge in the battery 105 over time based on, for instance, signals from the sensor 110. The computing device 115 may be configured to identify a relationship between the change in the open circuit voltage and the change in the state of charge, or this relationship may be previously determined and stored in a look-up table in, for instance, the memory device 120. In one possible approach, the relationship between the change in the open circuit voltage and the change in the state of charge may be a ratio between those characteristics of the battery 105. The computing device 115 may access the ratio of the change in the open circuit voltage to the change in the state of charge from the look-up table.

The computing device 115 may be configured to recognize that the parameter values may change as the conditions of the battery 105 change. For instance, the parameter values may change as the battery 105 ages. As such, the computing device 115 may be configured to update the parameter values by setting an initial parameter value, which may be the same as the most recently used parameter value, and by applying one or more regression procedures, such as but not limited to a Recursive Least Squares procedure, to the initial parameter value.

Moreover, the computing device 115 may be configured to recognize that the operating conditions of the battery 105 may affect the open circuit voltage determination. For instance, the signal excitation level and/or the temperature of the battery 105 may affect the ability of the computing device 115 to estimate the diffusion voltage of the battery 105. The diffusion voltage is one factor that may be used to determine the open circuit voltage. Accordingly, the computing device 115 may be configured to account for the signal excitation level and temperature of the battery 105 resulting in a more robust and accurate determination of the open circuit voltage.

The computing device 115 may be configured to implement various procedures to estimate the diffusion voltage value given the operating conditions of the battery before determining the open circuit voltage. The computing device 115 may also be configured to estimate multiple diffusion voltage values and determine which is the most appropriate to use to determine the open circuit voltage given the operating conditions of the battery 105. For purposes of illustration only, the computing device 115 disclosed is configured to estimate two diffusion voltage values using different procedures. However, the computing device 115 may be configured to estimate any number of diffusion voltage values.

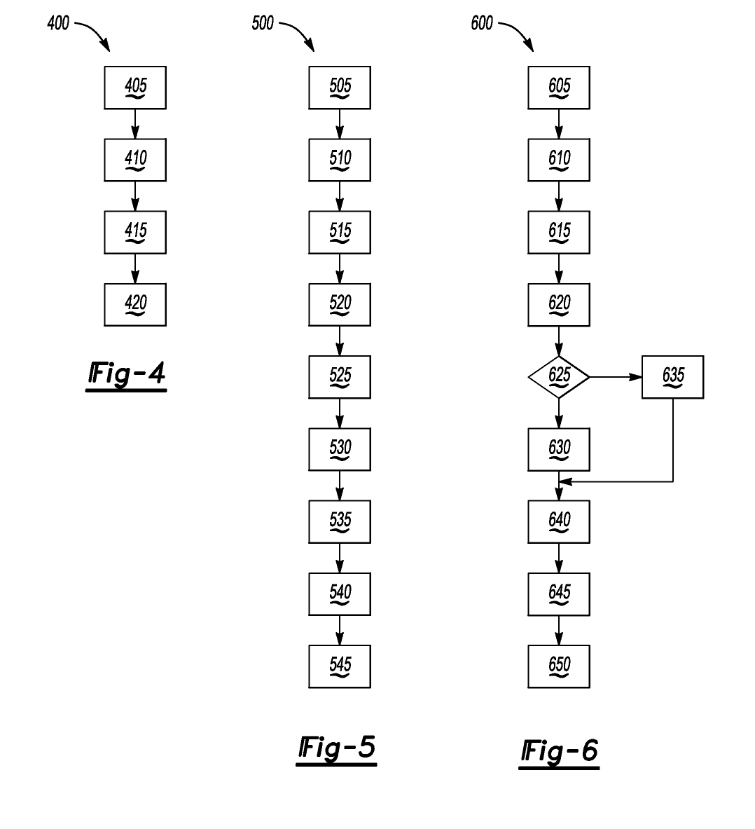

One procedure that may be used by the computing device 115 to estimate the diffusion voltage value may be to select a first diffusion voltage value from a look-up table stored in, for instance, the memory device 120. The computing device 115 may be configured to use the determined terminal voltage, accumulated charge (e.g., derived from the measured terminal current), and/or temperature of the battery 105 to select the first diffusion voltage value from the look-up table. The diffusion voltage values stored in the look-up table may include diffusion voltage values at various operating conditions of the battery 105. One example of this “look-up procedure” for estimating the first diffusion voltage value is described in greater detail below with reference to FIG. 4.

Another procedure, referred to below as an “estimation procedure,” may be used by the computing device 115 to adaptively estimate a second diffusion voltage value. For instance, using the estimation procedure, the computing device 115 may be configured to estimate and use various parameter values, which may be updated through one or more regression procedures, in addition to the terminal voltage, terminal current, accumulated charge, open circuit voltage at key-on, etc., to estimate the second diffusion voltage value. The second diffusion voltage values estimated using the estimation procedure may be most appropriate when the battery 105 is operating at normal operation conditions, such as when the signal excitation level of the battery 105 meets or exceeds a predetermined threshold. One example of this “estimation procedure” is described in greater detail below with respect to FIG. 5.

The computing device 115 may be configured to execute both the look-up procedure and the estimation procedure, and determine which of the two estimated diffusion voltage values (e.g., the first diffusion voltage value and the second diffusion voltage value) is the most appropriate to use given the operating conditions of the battery 105. For instance, the computing device 115 may be configured to determine the validity of one or both of the estimated diffusion voltage values and select the one determined to be the most valid based on factors such as the signal excitation level, etc. Moreover, if the computing device 115 at one time determines that the first diffusion voltage value is the most accurate and later determines that the second diffusion voltage value is the most accurate, the computing device 115 may be configured to apply a filtering procedure to transition between using the first diffusion voltage value and second diffusion voltage value to determine the open circuit voltage.

In general, the computing device 115 may employ any of a number of computer operating systems and generally include computer-executable instructions. The computer-executable instructions may be executed by a processor within the computing device 115. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The memory device 120 may include any device configured to store information in electronic form and provide the information to one or more electronic devices within the vehicle 100, including the computing device 115 and any control modules used in the vehicle 100. Like the computer-readable medium associated with the computing device 115, the memory device 120 may include any non-transitory (e.g., tangible) medium that has non-volatile and/or volatile media. In one possible approach, the memory device 120 is included in the computer-readable medium of the computing device 115. Alternatively, the memory device 120 may be separate from the computing device 115 (e.g., embodied in another electronic device, not shown). In addition, although only one memory device 120 is shown in FIG. 1, the vehicle 100 may include any number of memory devices 120 storing some or all of the information used by the computing device 115 and other control modules in the vehicle 100.

The memory device 120 may include one or more databases with information that may be accessed by the computing device 115 or other control modules in the vehicle 100. Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device (e.g., the same or a different computing device 115 illustrated in FIG. 1) employing a computer operating system such as one of those mentioned above, and are accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

In one possible approach, the database stored in the memory device 120 may include the look-up table with the relationship between the diffusion voltage value of the battery 105 based on one or more of the terminal voltage, the accumulated charge, the measured terminal current, the temperature of the battery 105, etc. Other values that may be stored in various look-up tables and/or database may include the relationship (e.g., ratio) between the change in the open circuit voltage relative to the change in the state of charge, the most recent and/or previously estimated parameter values, and the values measured by the sensor 110 and/or determined by the computing device 115 such as the previous and most recent terminal voltages, terminal currents, and temperatures measured.

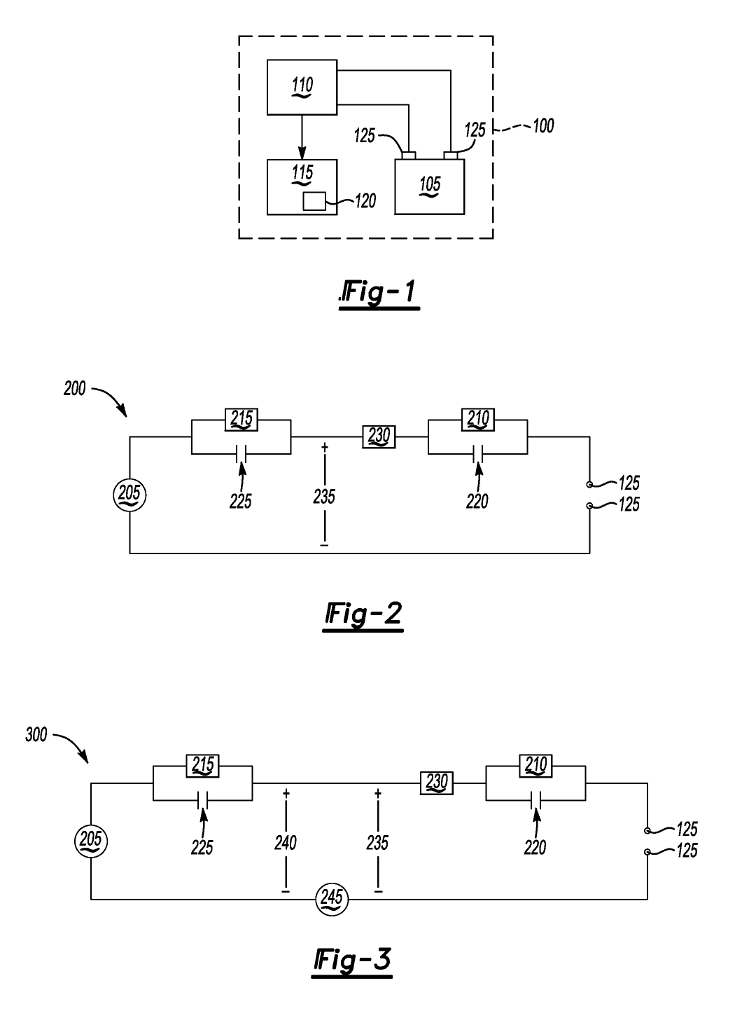

FIG. 2 illustrates an example two-resistor-capacitor-pair (e.g., a two-RC-pair) equivalent circuit 200 of an example battery 105 that may be used in the vehicle 100 of FIG. 1. The two-RC-pair circuit 200 of FIG. 2 is merely an example to illustrate the implementation of the real time determination of the open circuit voltage described herein. Other circuit models that characterize the dynamic behavior of the battery 105 in terms of the terminal current as the input and the terminal voltage as the output may be used to determine the open circuit voltage. The circuit 200 may be used by the computing device 115 to determine the open circuit voltage based on a diffusion voltage value selected from a look-up table, as described in the look-up procedure described below with respect to FIG. 4.

For purposes of illustration, the circuit 200 includes a voltage source 205, first and second resistive elements 210, 215, first and second capacitive elements 220, 225, and a third resistive element 230. The circuit 200 may have any number of voltage sources, resistive elements, and capacitive elements to model the battery 105. The voltage source 205 represents an open circuit (e.g., no load) voltage across the terminals 125 of the battery 105. The first and second resistive elements 210, 215 are each disposed in parallel with one of the capacitive elements (e.g., the first and second capacitive elements, 220, 225, respectively), presenting two RC pairs in the circuit 200 of FIG. 2. The voltage across one of the RC pairs (e.g., the first resistive element 210 and the first capacitive element 220) may represent the double layer voltage of the battery 105, while the voltage across the other of the RC pairs (e.g., the second resistive element 215 and the second capacitive element 225) may represent the diffusion voltage of the battery 105.

Accordingly, the terminal voltage of the circuit 200 may be expressed as

V(k)=V_{oc}(k)+I(k)R(k)+V_{dl}(k)+V_{diff}(k) 2

where k represents the present time step, V is the measured terminal voltage, I is the measured terminal current, V_{oc} is the open circuit voltage, R is the Ohmic resistance (e.g., of the third resistive element 230), and V_{dl} and V_{diff} (e.g., the voltages across the two RC pairs) are the double layer voltage and the diffusion voltage, respectively. Using Equation (2), the circuit 200 of FIG. 2 may be used to establish a relationship between the diffusion voltage and the open circuit voltage. Specifically, the relationship between the diffusion voltage and the open circuit voltage may be defined as a first voltage (V_{I}) in Equation (3), below:

V₁=V_{oc}+V_{diff} (3)

where V_{oc} is the open circuit voltage and V_{diff} is the diffusion voltage. The first voltage (V₁) is represented by element number 235 in FIG. 2. Solving for the open circuit voltage,

V_{oc}=V₁−V_{diff}. (4)

To solve Equation (4), the diffusion voltage value (V_{diff}) may be selected from a look-up table stored in the memory device 120 based on one or more of the terminal voltage, the terminal current, and the temperature of the battery 105 measured by the sensor. Further, the first voltage (V₁) can be derived or estimated from the terminal voltage and/or the terminal current measured by the sensor 110.

FIG. 3 illustrates an example two-RC-pair equivalent circuit 300 of an example battery 105 that may be used in the vehicle 100 of FIG. 1. Like that of FIG. 2, the two-RC-pair circuit 300 of FIG. 3 is merely an example to illustrate the implementation of the real time determination of the open circuit voltage described herein. Other circuit models that characterize the dynamic behavior of the battery 105 in terms of the terminal current as the input and the terminal voltage as the output may be used to determine the open circuit voltage. The circuit 300 may be used by the computing device 115 to determine the open circuit voltage based on a diffusion voltage value estimated using, for instance, the estimation procedure described below with respect to FIG. 5.

As illustrated in FIG. 3, the voltage source 205, first and second resistive elements 210, 215, first and second capacitive elements 220, 225, and the third resistive element 230 may be similar to those described above with respect to the circuit 200 illustrated in FIG. 2. The voltage source 205, however, may represent the open circuit voltage of the battery 105 at key-on. That is, in response to detecting a key-on event, the computing device 115 may determine the open circuit voltage. The change in the open circuit voltage may be represented by the voltage source 245.

The computing device 115 may be configured to define terminal voltage V of the circuit 200 using an expression such as:

V(k)=θ₁V(k−1)+θ₂I(k)+θ₃I(k−1)+θ₄ (5)

where θ₁, θ₂, θ₃, and θ₄ each represent model parameter values, such as a value of one or more resistive elements or other characteristics of the battery 105, and k represents the sampling time step. Moreover, the double layer voltage may be defined as:

$${V}_{dl} = {θ}_{1} V ( k - 1 ) + {θ}_{3} I ( k - 1 ) - \frac{{θ}_{1} {θ}_{4}}{1 - {θ}_{1}} . \qquad ( 6 )$$

The computing device 115 may be configured to solve Equations (5) and (6) by estimating the parameter values and by using the terminal voltage and terminal current measured by the sensor 110. Equations (5) and (6) are merely an example as the computing device 115 may model the terminal voltage and the double layer voltage of the battery 105 using different expressions depending on the configuration of the battery 105.

In addition to Equation (3), the first voltage may be further defined as:

V₁=V−V_{dl}−IR (7)

The computing device 115 may be configured to solve for the first voltage (V₁) in Equation (7) using the measured terminal voltage (V), the measured terminal current (I), the value of the third resistive element 230 (R), and the double layer voltage determined using Equation (6).

FIG. 3 further defines a second voltage (V₂) that is represented by the element number 240. The second voltage may be defined as follows:

V₂=V₁−ΔV_{oc} (8)

where ΔV_{oc} represents the change in the open circuit voltage (represented by element 245 in FIG. 3). The computing device 115 may be configured to determine the change in the open circuit voltage based on a relationship with the change in the state of charge. For example, the computing device 115 may determine the change in the state of charge based on a change of the residual capacity of the battery relative to the reserve capacity of the battery. With the change in the state of charge, the computing device 115 may determine the change in the open circuit voltage using, for instance, a look-up table stored in the memory device 120.

The computing device 115 may be further configured to estimate the diffusion voltage value (V_{diff}) of the circuit 300 using the second voltage (V₂). In addition to Equation (8), the second voltage (V₂) may be further defined by the following:

V₂(k)=μ₁V₂(k−1)+μ₂I(k−1)+μ₃ (9)

where μ₁, μ₂, and μ₃, are model parameter values that may be the same or different than the model parameter values discussed above with respect to Equations (5) and (6). For instance, the parameter values of Equations (5) and (6) may represent a first set of parameter values representing characteristics of one part of the battery 105 while the parameter values of Equation (9) represent a second set of parameter values representing another part of the battery 105.

Moreover, the computing device 115 may be configured to estimate the diffusion voltage value (V_{diff}) using Equation (10), below:

$${V}_{diff} = {μ}_{1} {V}_{2} ( k - 1 ) + {μ}_{2} I ( k - 1 ) - \frac{{μ}_{1} {μ}_{3}}{1 - {μ}_{1}} . \qquad ( 10 )$$

The computing device 115 may be configured to solve Equations (9) and (10) by estimating the parameter values, as described below with respect to FIG. 5, and by using the terminal voltage and terminal current measured by the sensor 110. As presented above with respect to Equation (4), the open circuit voltage (V_{oc}) may be determined by the computing device 115 from the difference between the first voltage (V₁) and the diffusion voltage value (V_{diff}) determined from Equation (10). Like Equations (5) and (6), Equations (9) and (10) are merely an example as the computing device 115 may model the second voltage and the diffusion voltage of the battery 105 using different expressions depending on the configuration of the battery 105.

FIG. 4 illustrates an example flowchart of a look-up procedure 400 that may be used by the computing device 115 of FIG. 1 to estimate a first diffusion voltage value and determine an open circuit voltage of the battery 105 based on the first diffusion voltage value. The look-up procedure 400 may be used, for instance, when the diffusion voltage value estimated using other procedures is deemed to yield less accurate results.

At block 405, the computing device 115 may determine the terminal voltage, the terminal current, and the temperature of the battery 105 based on, for instance, signals generated by the sensor 110. In one possible approach, the computing device 115 may derive an accumulated charge based at least in part on the terminal current.

At block 410, the computing device 115 may select the first diffusion voltage value from a look-up table stored in, for instance, the memory device 120. The computing device 115 may select the first diffusion voltage value from the look-up table using any one or more of the characteristics determined at block 405.

At block 415, the computing device 115 may calculate a first voltage defined as the sum of the first diffusion voltage value and the open circuit voltage. The computing device 115 may determine the first voltage from any one or more of the characteristics determined at block 405 such as the terminal voltage, the terminal current, the temperature of the battery 105, etc.

At block 420, the computing device 115 may calculate the open circuit voltage based on a difference between the first voltage and the first diffusion voltage value as indicated above with respect to Equation (4).

FIG. 5 illustrates an example flowchart of the estimation procedure 500 that may be used by the computing device 115 of FIG. 1 to estimate the second diffusion voltage value and determine the open circuit voltage accordingly. The estimation procedure 500 may be used, for instance, when the signal excitation level of the battery 105 is sufficient, and/or if the diffusion voltage value estimated using other procedures is deemed to yield less reliable results.

At block 505, the computing device 115 may determine the terminal voltage, the terminal current, and the temperature of the battery 105 based on, for instance, signals generated by the sensor 110. In one possible approach, the computing device 115 may derive an accumulated charge based at least in part on the terminal current.

At block 510, the computing device 115 may estimate a first set of parameter values associated with a state of health of the battery. For instance, the computing device 115 may use a regression procedure, such as a Recursive Least Squares procedure, to estimate the first set of parameters.

At block 515, the computing device 115 may calculate a double layer voltage of the battery 105 using, for instance, the characteristics of the battery 105 determined at block 505 and the first set of estimated parameter values determined at block 505. One possible expression defining the double layer voltage may be the expression presented above in Equation (6).

At block 520, the computing device 115 may calculate the first voltage based at least in part on a relationship between the characteristics of the battery 105 identified at block 505, the parameter values estimated at block 510, and the double layer voltage determined at block 515. For instance, the computing device 115 may use an equation similar to Equation (7) to determine the first voltage.

At block 525, the computing device 115 may determine a change in open circuit voltage of the battery 105 over time. The change in the open circuit voltage may be determined based on a relationship between the change in the open circuit voltage and a change in the state of charge. The computing device 115 may, therefore, determine the change in the state of charge from, for instance, one or more of the characteristics of the battery 105 determined at block 505. The computing device 115 may further derive the change in the open circuit voltage in light of the state of charge using a look-up table stored in the memory device 120.

At block 530, the computing device 115 may calculate the second voltage based at least in part on the first voltage and the change in the open circuit voltage as presented in Equation (8) above.

At block 535, the computing device 115 may estimate the second set of parameter values associated with the state of health of the battery. For instance, the computing device 115 may use a regression procedure, which may be the same or a different regression procedure used at block 510, to estimate the second set of parameters.

At block 540, the computing device 115 may estimate the second diffusion voltage based at least in part on one or more of the characteristics of the battery 105 determined at block 505 (e.g., the terminal voltage and the accumulated charge) and the second set of parameter values estimated at block 535.

At block 545, the computing device 115 may calculate the open circuit voltage based on a difference between the first voltage and the first diffusion voltage value as indicated above with respect to Equation (4).

FIG. 6 illustrates an example flowchart of a process 600 that may be used by the computing device 115 of FIG. 1 to fuse the look-up procedure 400 and the estimation procedure 500. This way, the computing device 115 may determine the open circuit voltage of the battery 105 using the most reliable estimations of the diffusion voltage value.

At block 605, the computing device 115 may determine the terminal voltage, the terminal current, and the temperature of the battery 105 based on, for instance, signals generated by the sensor 110. In one possible approach, the computing device 115 may derive an accumulated charge based at least in part on the terminal current.

At block 610, the computing device 115 may estimate the first diffusion voltage value using one or more blocks of the look-up procedure 400 described above with respect to FIG. 4. As a result, the computing device 115 may select the first diffusion voltage value from a look-up table based on the characteristics of the battery 105 determined at block 605.

At block 615, the computing device 115 may estimate the second diffusion voltage value using one or more blocks of the estimation procedure 500 described above with respect to FIG. 5. With the estimation procedure 500 of FIG. 5, the computing device 115 may estimate the second diffusion voltage based at least in part on one or more of the characteristics of the battery 105 determined at block 605 (e.g., the terminal voltage and the accumulated charge) and one or more sets of parameter values.

At block 620, the computing device 115 may determine the validity of one or more of the first and second diffusion voltage values using the characteristics of the battery 105 determined at block 605. Alternatively, the computing device 115 may recognize one of the diffusion voltage values (e.g., the second diffusion voltage value) as a default diffusion voltage value and only select the other diffusion voltage value (e.g., the first diffusion voltage value) if the second diffusion voltage value is deemed invalid at block 620.

At decision block 625, the computing device 115 may select one of the first and second diffusion voltage values based on the determination of validity at block 620. For example, if the computing device 115 determines that the signal excitation level is too low (e.g., is below the predetermined threshold), the computing device 115 may determine that the second diffusion voltage value is invalid at block 620. Thus, at block 625, the computing device 115 may select the first diffusion voltage value as indicated at block 630 and proceed to block 640 with the first diffusion voltage value. If, however, the computing device 115 determines that the signal excitation level exceeds a predetermined threshold, the computing device 115 may determine that the second diffusion voltage value is valid. Accordingly, the process 600 may continue with the second diffusion voltage value, as indicated at block 635 and proceed to block 640 with the second diffusion voltage value.

At block 640, the computing device 115 may apply a filtering procedure to the selected diffusion voltage value to provide a smooth transition between diffusion voltage values if, for instance, the computing device 115 switches between the first diffusion voltage value and the second diffusion voltage value, and vice versa.

At block 645, the computing device 115 may update the selected diffusion voltage value based on, for instance, the result of the filtering procedure applied at block 640.

At block 650, the computing device 115 may determine the open circuit voltage of the battery based, at least in part, on the selected diffusion voltage value as estimated or as a result of the filtering procedure of block 640. For instance, the computing device 115 may determine the open circuit voltage using an expression defining the relationship between the diffusion voltage value and the open charge voltage, such as Equation (4), above.

While the best modes for carrying out the invention have been described in detail, those familiar with the art to which this invention relates will recognize various alternative designs and embodiments for practicing the invention within the scope of the appended claims.

1. A method comprising:
estimating a first diffusion voltage value of a battery by selecting the first diffusion voltage value from a look-up table;
estimating a second diffusion voltage value of the battery using an estimation procedure;
selecting at least one of the estimated first and second diffusion voltage values; and
determining, via a computing device, an open circuit voltage of the battery based at least in part on the selected diffusion voltage value.

2. A method as set forth in claim 1, further comprising determining at least one of a terminal voltage, an accumulated charge, and a temperature of the battery.

3. A method as set forth in claim 2, wherein estimating the first diffusion voltage value includes selecting the first diffusion voltage value from the look-up table based at least in part on one or more of the terminal voltage, the accumulated charge, and the temperature.

4. A method as set forth in claim 2, wherein the estimation procedure includes:
estimating a first set of parameter values associated with a state of health of the battery;
calculating, via the computing device, a double layer voltage based at least in part on the estimated parameter values;
determining a change in an open circuit voltage of the battery over time; and
estimating a second set of parameter values associated with the state of health of the battery.

5. A method as set forth in claim 4, wherein estimating the second diffusion voltage value includes estimating the second diffusion voltage value based at least in part on one or more of the terminal voltage, the accumulated charge, and the second set of parameter values.

6. A method as set forth in claim 4, wherein determining the change in the open circuit voltage includes:
determining a change in the state of charge of the battery; and
deriving the change in the open circuit voltage from the change in the state of charge.

7. A method as set forth in claim 4, wherein estimating the first set of parameter values includes applying a regression procedure to the first set of parameter values.

8. A method as set forth in claim 4, wherein estimating the second set of parameter values includes applying a regression procedure to the second set of parameter values.

9. A method as set forth in claim 2, wherein determining the open circuit voltage includes determining the open circuit voltage based at least in part on the selected diffusion voltage value and one or more of the terminal voltage, the accumulated charge, and the temperature.

10. A method as set forth in claim 1, wherein selecting at least one of the estimated first and second diffusion voltage values includes determining the validity of one or more of the first and second diffusion voltage values.

11. A method as set forth in claim 1, further comprising applying a filter procedure to the selected diffusion voltage value prior to determining the open circuit voltage.

12. A vehicle comprising:
a battery;
at least one sensor configured to measure at least one of a terminal voltage, a terminal current, and a temperature of the battery; and
a computing device in communication with the at least one sensor and configured to estimate a first diffusion voltage value of the battery by selecting the first diffusion voltage value from a look-up table, estimate a second diffusion voltage value of the battery using an estimation procedure, select at least one of the estimated first and second diffusion voltage values, and determine an open circuit voltage of the battery based at least in part on the selected diffusion voltage value.

13. A vehicle as set forth in claim 12, wherein the computing device is configured to derive an accumulated charge from the measured terminal current.

14. A vehicle as set forth in claim 13, wherein the computing device is configured to select the first diffusion voltage value from the look-up table based at least in part on one or more of the terminal voltage, the accumulated charge, and the temperature during the first procedure.

15. A vehicle as set forth in claim 13, wherein the computing device is configured to estimate a first set of parameter values associated with a state of health of the battery and calculate a double layer voltage based at least in part on the estimated parameter values.

16. A vehicle as set forth in claim 15, wherein the computing device is configured to determine a change in an open circuit voltage of the battery over time and estimate a second set of parameter values associated with the state of health of the battery.

17. A vehicle as set forth in claim 16, wherein the computing device is configured to estimate the second diffusion voltage value based at least in part on one or more of the terminal voltage, the accumulated charge, the double layer voltage, the change in the open circuit voltage, the first set of parameter values, and the second set of parameter values.

18. A vehicle as set forth in claim 13, wherein the computing device is configured to determine the open circuit voltage based at least in part on the selected diffusion voltage value and one or more of the terminal voltage, the accumulated charge, and the temperature.

19. A non-transitory computer-readable medium tangibly embodying computer-executable instructions comprising:
estimating a first diffusion voltage value of a battery by selecting the first diffusion voltage value from a look-up table;
estimating a second diffusion voltage value of the battery using an estimation procedure;
selecting at least one of the estimated first and second diffusion voltage values; and
determining an open circuit voltage of the battery based at least in part on the selected diffusion voltage value.

20. A non-transitory computer-readable medium tangibly embodying computer-executable instructions as set forth in claim 19, further comprising:
determining at least one of a terminal voltage, an accumulated charge, and a temperature of the battery;
wherein estimating the first diffusion voltage value includes selecting the first diffusion voltage value from the look-up table based at least in part on one or more of the terminal voltage, the accumulated charge, and the temperature; and
wherein the estimation procedure includes estimating a first set of parameter values associated with a state of health of the battery, calculating a double layer voltage based at least in part on the estimated parameter values, determining a change in an open circuit voltage of the battery over time, estimating a second set of parameter values associated with the state of health of the battery, and estimating the second diffusion voltage value based at least in part on one or more of the terminal voltage, the accumulated charge, the double layer voltage, the change in the open circuit voltage, the first set of parameter values, and the second set of parameter values.
